(19) United States
(12) Patent Application Publication
(10) Pub. No.: US 2025/0074173 A1
(43) Pub. Date: Mar. 6, 2025

(54) FOLDING ROOF AND VEHICLE

(71) Applicant: Fuzhou Yisen Automotive Parts Co., Ltd, Fuzhou City (CN)

(72) Inventors: Jitao Huang, Fuzhou City (CN); Zhiwei Zhang, Fuzhou City (CN); Liqing Chen, Fuzhou City (CN)

(21) Appl. No.: 18/952,816

(22) Filed: Nov. 19, 2024

(30) Foreign Application Priority Data
Mar. 26, 2024 (CN) 202410348947.5

(51) Int. Cl. B60J 7/12

(52) U.S. Cl. CPC B60J 7/1291

(57) ABSTRACT

The invention relates to a folding roof and a vehicle. A middle roof portion is connected between a front roof portion and a rear roof portion, and the front roof portion and the rear roof portion are foldable relative to each other through the middle roof portion; the front roof portion is a hard shell portion, the rear roof portion is a hard shell portion, the middle roof portion includes a canopy cloth, the canopy cloth is made of a soft material, and the canopy cloth is a soft roof portion. The soft roof and the hard roof can be quickly convertible, the hard roof is used as a connection portion with the vehicle body, and the lock catch is used for fit to facilitate disassembly, and the hard roof is combined with the soft roof, so that the overall space of the folded roof is small.

### TECHNICAL FIELD

The present invention belongs to the technical field of vehicles, and specifically relates to a folding roof and a vehicle.

### BACKGROUND

There are more and more types of convertible cars on the market, and roofs thereof can be divided into hard roof and soft roof. The hard roof is of a detachable structure, and the soft roof is mostly of an openable and foldable structure. Both structures can achieve the effect of opening the car roof. The hard roof has the advantage of allowing mounting of a luggage rack, but has the disadvantage of cumbersome opening due to the necessity of disassembly. The soft roof has the advantage of convenient opening, but has the disadvantage of poor connection between a soft connection of the soft roof and a rigid connection portion of the vehicle body which is prone to rework, resulting in high production costs.

### SUMMARY

In order to solve the above problems of the prior art, the present invention provides a folding roof and a vehicle, which combine the advantages of a soft roof and a hard roof, and enables quick dismounting and mounting of the roof.

In order to achieve the above object, the present invention uses the following technical solution.

As an aspect of the present invention, there is provided a folding roof, including: a front roof portion, a rear roof portion and a middle roof portion, where the middle roof portion is connected between the front roof portion and the rear roof portion, and the front roof portion and the rear roof portion are foldable relative to each other through the middle roof portion.

The front roof portion is a hard shell portion, the rear roof portion is a hard shell portion, the middle roof portion includes a canopy cloth, the canopy cloth is made of a soft material, and the canopy cloth is a soft roof portion.

A front end of the canopy cloth is connected with the front roof portion by a front fixing mechanism; and a rear end of the canopy cloth is connected with the rear roof portion by a rear fixing mechanism.

Further, the front roof portion includes a front cross member, a first connector is embedded in the front cross member, a first lock catch is connected to the first connector, and the front roof portion is detachably connected with a vehicle body by the first lock catch.

The rear roof portion includes a rear cross member, a second lock catch is connected to the rear cross member, and the rear roof portion is detachably connected with the vehicle body by the second lock catch.

Further, the middle roof portion further includes a front soft roof frame respectively provided on both sides of the front roof portion and a rear soft roof frame respectively provided on both sides of the rear roof portion, one end of the front soft roof frame is connected with the front roof portion, one end of the rear soft roof frame is connected with the rear roof portion, an end face of the other end of the front soft roof frame is in contact with an end face of the other end of the corresponding rear soft roof frame, or a preset gap is provided between an end face of the other end of the front soft roof frame and an end face of the other end of the corresponding rear soft roof frame.

A front portion of the canopy cloth is connected with the front roof portion, and a rear portion of the canopy cloth is connected with the rear roof portion; both side edges of the canopy cloth are matched with the corresponding front soft roof frame and rear soft roof frame.

Further, the middle roof portion further includes a first link assembly and a second link assembly arranged at intervals, more than one support rod is connected between the first link assembly and the second link assembly, fixing cloth strips are connected to the canopy cloth, the fixing cloth strips are connected with the support rods, and the first link assembly is structurally symmetrical to the second link assembly.

Further, the second link assembly includes a front connector and a rear connector, the front connector is connected with the corresponding front soft roof frame, the rear connector is connected with the corresponding rear soft roof frame, one end of the front connector is connected with the front cross member by a second connector, one end of the rear connector is connected with the rear cross member by a corresponding nutted connector, a front rotary connection portion is formed on the other end of the front connector, one end of the rear connector is connected with the rear cross member by a corresponding nutted connector, a rear rotary connection portion is formed on the other end of the rear connector, and the front rotary connection portion and the rear rotary connection portion are rotatably connected by a first rotating shaft, so that the front roof portion and the rear roof portion rotate relative to each other with the first rotating shaft as a fulcrum.

Further, the second link assembly further includes a four-link mechanism.

Further, the four-link mechanism includes a first link, a second link, a third link and a fourth link, one end of the first link and the rear connector are rotatably connected by a second rotating shaft, and a center of the second rotating shaft is higher than a center of the first rotating shaft; one end of the second link and the front connector are rotatably connected by a third rotating shaft; the other end of the first link and the second link close to the third rotating shaft are rotatably connected by a fourth rotating shaft; one end of the third link and the fourth rotating shaft are rotatably connected; one end of the fourth link and the front connector close to the front cross member are rotatably connected by a fifth rotating shaft; the other end of the third link and a middle portion of the fourth link are rotatably connected by a sixth rotating shaft; a support rod is connected between two second links, and both ends of the support rod are respectively connected with the corresponding second link by a link connector; a support rod is connected between two fourth links, and both ends of the support rod are respectively connected with the corresponding fourth link by a link connector.

Further, the folding roof further includes a gas spring, a fixed end of the gas spring is rotatably connected to the front connector, and a free end of the gas spring is rotatably connected to the rear connector.

Further, the folding roof includes a pull wire mechanism, the pull wire mechanism includes a tension spring and a pull wire connected to the rear soft roof frame or the front soft roof frame, and the tension spring is connected to the rear soft roof frame by a tension spring fixing plate; and one end of the pull wire is matched with the tension spring, and the other end of the pull wire passes through a corresponding edge of the canopy cloth and is connected with a pull wire bracket on the front soft roof frame or the rear soft roof frame.

Further, the four-link mechanism includes a fifth link, a sixth link, a seventh link and an eighth link, and one end of the fifth link and the rear connector close to the rear rotary connection portion are rotatably connected by a seventh rotating shaft; one end of the sixth link and the front connector are rotatably connected by an eighth rotating shaft; the other end of the fifth link and the other end of the sixth link are rotatably connected by a ninth rotating shaft; one end of the seventh link and the front connector are rotatably connected by an eleventh rotating shaft, one end of the eighth link is rotatably connected with the eighth rotating shaft, and the other end of the eighth link is rotatably connected with a middle and lower portion of the seventh link by a tenth rotating shaft; and a support rod is connected between upper portions of two seventh links.

As another aspect of the present invention, there is provided a vehicle including a vehicle body to which a folding roof as described above is connected.

The folding roof and the vehicle of the present invention have the following beneficial effects: 1. the front roof portion is connected with the vehicle body by the first lock catch, and the rear roof portion is connected with the vehicle body by the second lock catch, thus realizing mounting of the folding roof and the vehicle body; when the folding roof needs to be folded, the first lock catch is opened, and under the action of an external force, folding is carried out through the link assembly of the middle roof portion to achieve the folding of the roof, the middle roof portion adopts a soft roof design, so that the folded roof occupies a small space; and the second lock catch can also be opened to remove the whole folding roof, thus realizing convenient disassembly of the folding roof and having strong practicability.
2. In the present application, the soft roof and the hard roof can be quickly convertible, the hard roof is used as a connection portion with the vehicle body, and the lock catch is used for fit to facilitate disassembly, and the hard roof is combined with the soft roof, so that the overall space of the folded roof is small; and the support rods are fixed on the first link assembly and the second link assembly, which enables to change positions in the process of opening or closing the roof in a follow-up manner, thus achieving the effect of supporting the canopy cloth when the roof is closed and folding the canopy cloth and occupying a small space when the roof is opened.
3. The gas spring is mounted on the middle roof portion to achieve a buffering effect when the roof is opened. The front soft roof frame and the rear soft roof frame are respectively provided with side sealing strips through fixing brackets, so that the fixing bracket can be adjusted to achieve the optimal sealing effect. The pull wire passes through the edge of the canopy cloth to prevent the canopy cloth from wrinkling and deforming. One end of the pull wire is provided with a tension spring structure, which enables to adjust the length of the pull wire in a follow-up manner.

### BRIEF DESCRIPTION OF THE DRAWINGS

The accompanying drawings, which are incorporated in and constitute a part of the present application, are included to provide a further understanding of the present invention, and illustrative embodiments of the present invention and the description thereof are included to illustrate the present invention, but are not to be construed as unduly limiting the present invention.

FIG. 1 is a first structural schematic diagram of a folding roof according to Embodiment 1 of the present invention;

FIG. 2 is a second structural schematic diagram of the folding roof according to Embodiment 1 of the present invention;

FIG. 3 is a structural bottom view of the folding roof according to Embodiment 1 of the present invention;

FIG. 4 is a schematic diagram of a state in which the folding roof according to Embodiment 1 of the present invention is being folded;

FIG. 5 is a schematic diagram of a state in which the folding roof according to Embodiment 1 of the present invention has been folded;

FIG. 6 is a structural schematic diagram of a pull wire mechanism according to Embodiment 1 of the present invention;

FIG. 7 is a structural schematic diagram of a front roof portion according to Embodiment 1 of the present invention;

FIG. 8 is a structural schematic diagram of a first connector and a second connector in the front roof portion according to Embodiment 1 of the present invention;

FIG. 9 is a structural schematic diagram of a rear cross member according to Embodiment 1 of the present invention;

FIG. 10 is a schematic diagram of a mounting state of a second lock catch according to Embodiment 1 of the present invention;

FIG. 11 is a structural exploded view of the second lock catch according to Embodiment 1 of the present invention;

FIG. 12 is a structural schematic diagram of a foolproof mechanism of the second lock catch according to Embodiment 1 of the present invention;

FIG. 13 is a structural sectional view of a front fixing mechanism according to Embodiment 1 of the present invention;

FIG. 14 is a structural exploded view of a rear fixing mechanism according to Embodiment 1 of the present invention;

FIG. 15 is a structural sectional view of a front fixing mechanism according to Embodiment 1 of the present invention;

FIG. 16 is a structural schematic diagram of a four-link mechanism according to Embodiment 2 of the present invention.

### DESCRIPTION OF THE EMBODIMENTS

In order to make the object, technical solution and advantages of the present invention more clear, the technical solution of the present invention will be described clearly and completely below in conjunction with the specific embodiments and accompanying drawings of the present invention. Obviously, the described embodiments are only some but not all embodiments of the present invention. Based on the embodiments of the present invention, all other embodiments obtained by those of ordinary skill in the art without creative work fall within the protection scope of the present invention.

### Embodiment 1

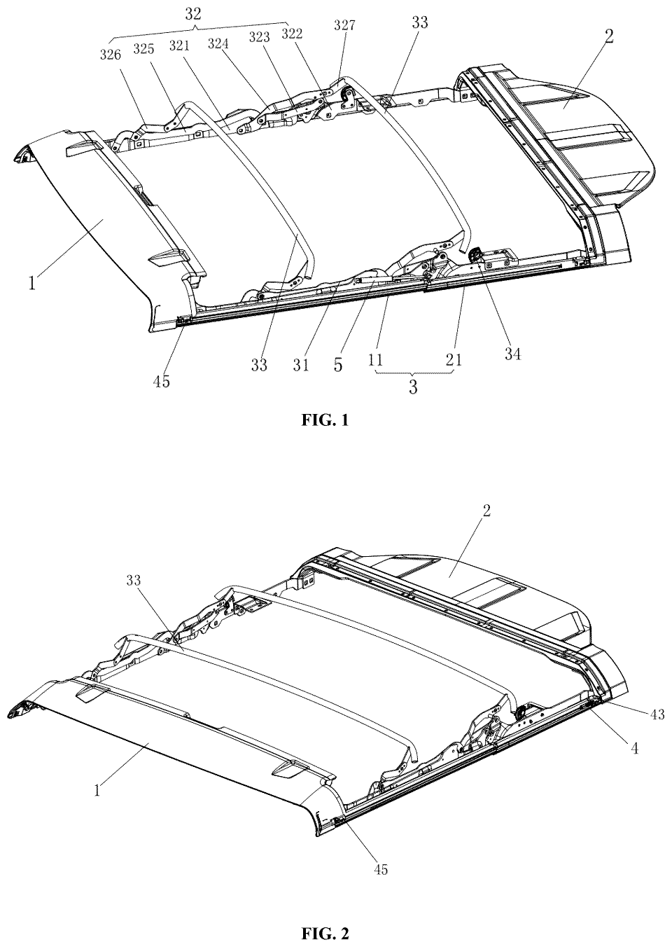

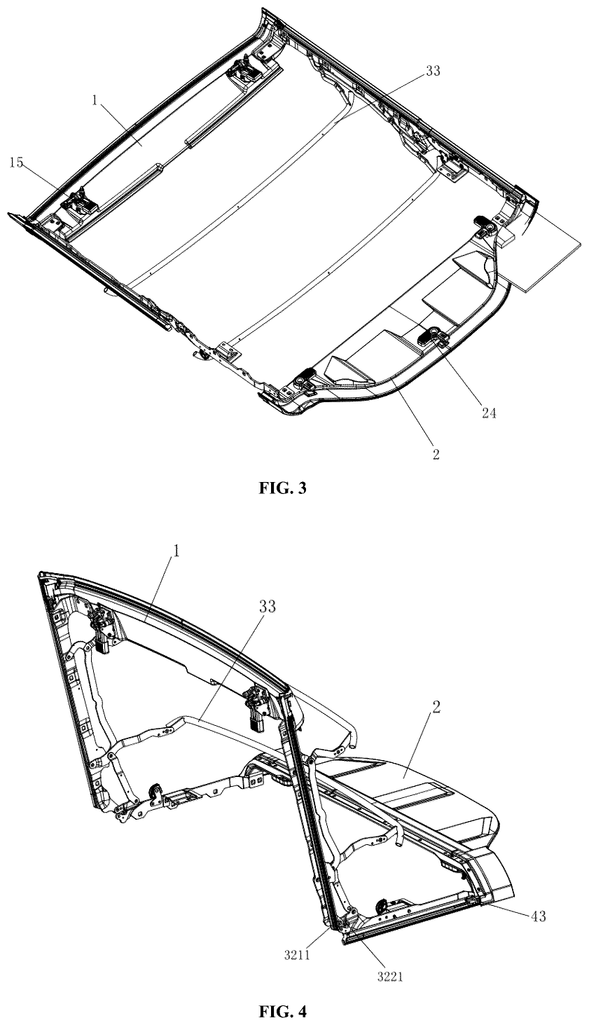

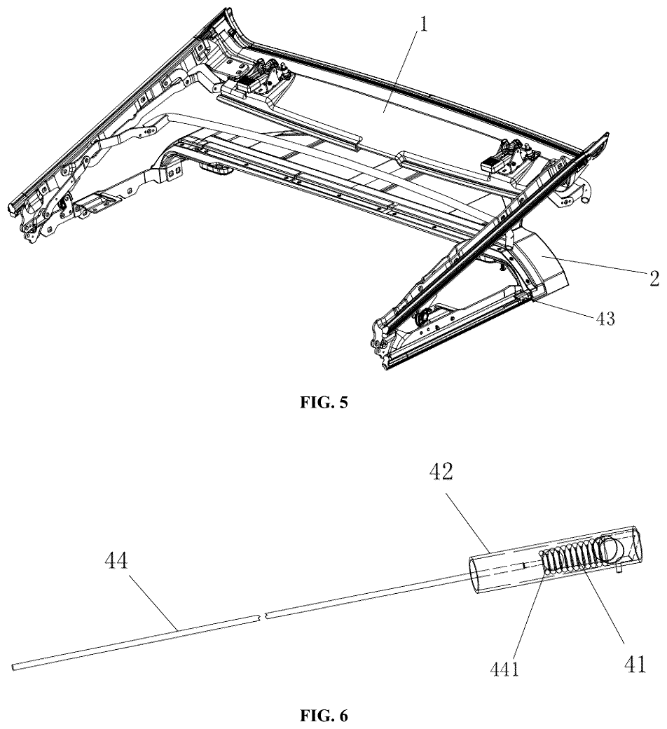

A folding roof according to an embodiment of the present application, as shown in FIGS. 1-5, includes a front roof portion 1, a rear roof portion 2 and a middle roof portion 3, and these roof portions are designed to act as shell portions and completely cover a passenger compartment of a vehicle when the folding roof is closed. The front roof portion 1 is detachably fixed on the vehicle body, the rear roof portion 2 is detachably fixed on the vehicle body, the middle roof portion 3 is connected between the front roof portion 1 and the rear roof portion 2, and the front roof portion 1 and the rear roof portion 2 are foldable relative to each other through the middle roof portion 3. It should be noted that the front roof portion and the rear roof portion are distinguished by a front portion and a back portion of the vehicle, the roof portion close to the front portion of the vehicle is the front portion, and the roof portion close to the back portion of the vehicle is the rear portion, which is common knowledge in the art and will not be described in detail.

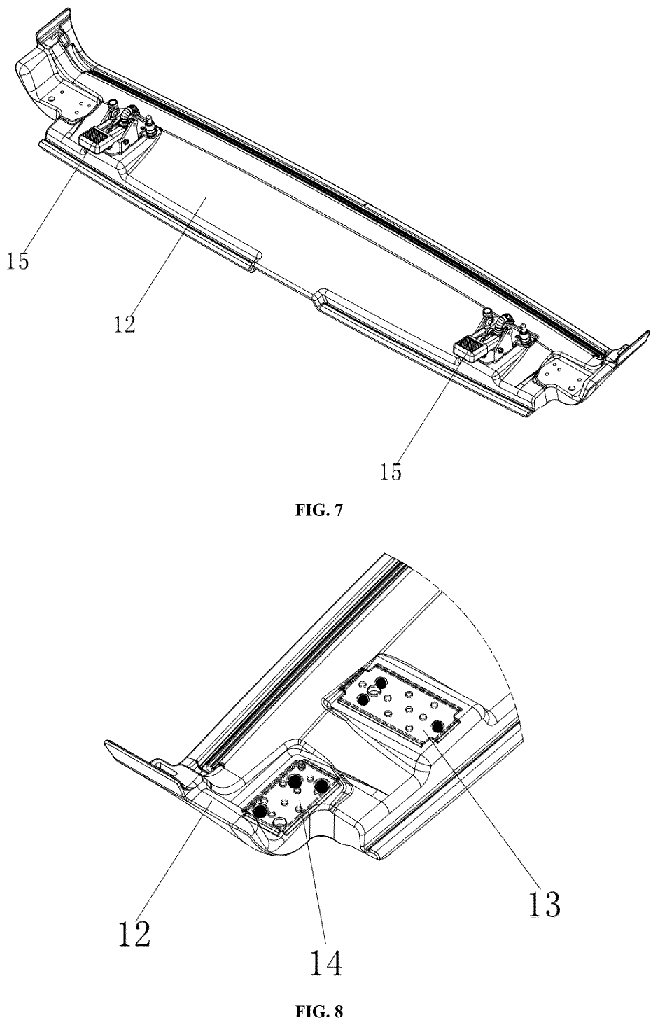

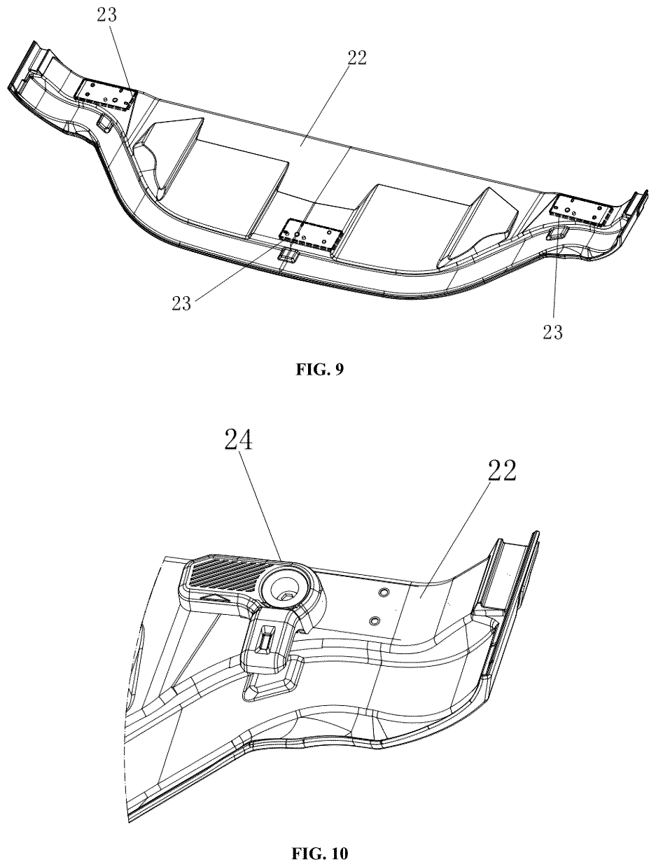

In one embodiment, as shown in FIGS. 7-9 and 13, the front roof portion 1 is a hard shell portion, and includes a front cross member 12; the front cross member 12 is made by a PHC pressing process which is the prior art and will not be described in detail; the front cross member 12 is a hard shell portion which is called a hard roof; and a first connector 13 and a second connector 14 are embedded in the front cross member 12, the first connector 13 and the second connector 14 are both iron pieces with nuts, a first lock catch 15 is connected to the first connector 13, and the front roof portion 1 is detachably connected with the vehicle body by the first lock catch 15. It should be noted that the first lock catch 15 is the prior art and will not be described in detail.

The rear roof portion 2 is a hard shell portion, and includes a rear cross member 22; the rear cross member 22 is made by a PHC pressing process which is the prior art and will not be described in detail; the rear cross member 22 is a hard shell portion which is called a hard roof; a plurality of nutted connectors 23 are embedded in the rear cross member 22; and a second lock catch 24 is connected to the rear cross member 22 of the rear roof portion 2, and the rear roof portion 2 is detachably connected with the vehicle body by the second lock catch 24.

The middle roof portion 3 includes a front soft roof frame 11 respectively provided on both sides of the front roof portion 1, a rear soft roof frame 21 respectively provided on both sides of the rear roof portion 2 and a canopy cloth 35; one end of the front soft roof frame 11 is connected with the front roof portion 1, one end of the rear soft roof frame 21 is connected with the rear roof portion, an end face of the other end of the front soft roof frame 11 is in contact with an end face of the other end of the corresponding rear soft roof frame 21, or a preset gap is provided between an end face of the other end of the front soft roof frame 11 and an end face of the other end of the corresponding rear soft roof frame 21, which facilitate folding between the front soft roof frame 11 and the rear soft roof frame 21; and a fitting surface between the end surface of the other end of the front soft roof frame 11 and the end surface of the other end of the corresponding rear soft roof frame 21 is an inclined surface, which facilitates the folding between the front soft roof frame 11 and the rear soft roof frame 21.

The canopy cloth 35 is made of a soft material, such as cloth, and called a soft roof portion; fixing cloth strips are connected to the canopy cloth 35, and the fixing cloth strips are connected with the support rods 33 by blind rivets; the support rods 33 are located on an inner side of the canopy cloth 35 and does not affect the appearance; a front portion of the canopy cloth 35 is connected with the front roof portion 1, and a rear portion of the canopy cloth 35 is connected with the rear roof portion 2; both side edges of the canopy cloth 35 fit the corresponding front soft roof frame 11 and rear soft roof frame 21, so that the front roof portion 1, the rear roof portion 2 and the middle roof portion 3 form an integral structure; the front soft roof frame 11 and the rear soft roof frame 21 are respectively provided with fitting grooves fitting the edges of the canopy cloth 35, so that the canopy cloth 35 can fit the fitting grooves and can be folded, and cannot be separated from the front soft roof frame 11 and the rear soft roof frame 21; and side sealing strips are respectively mounted on the front soft roof frame 11 and the rear soft roof frame 21 by fixing brackets.

The middle roof portion 3 further includes a first link assembly 31 and a second link assembly 32 arranged at intervals, more than one support rod 33 is connected between the first link assembly 31 and the second link assembly 32, and the first link assembly 31 is structurally symmetrical to the second link assembly 32.

The second link assembly 32 includes a front connector 321 and a rear connector 322; the front connector 321 is connected with the corresponding front soft roof frame 11, and the rear connector 322 is connected with the corresponding rear soft roof frame 21; one end of the front connector 321 is connected with the front cross member 12 by the second connector 14, one end of the rear connector 322 is connected with the rear cross member 22 by the corresponding nutted connector 23, a front rotary connection portion 3211 is formed on the other end of the front connector 321, and one end of the rear connector 322 is connected with the rear cross member 22 by the corresponding nut connector 23; and a rear rotary connection portion 3221 is formed on the other end of the rear connector 322, and the front rotary connection portion 3211 and the rear rotary connection portion 3221 are rotatably connected by a first rotating shaft, so that the front roof portion 1 and the rear roof portion 2 rotate relative to each other with the first rotating shaft as a fulcrum.

The second link assembly 32 further includes a four-link mechanism, and the four-link mechanism includes a first link 323, a second link 324, a third link 325 and a fourth link 326; one end of the first link 323 and the rear connector 322 close to the rear rotary connection portion 3221 are rotatably connected by a second rotating shaft, and a center of the second rotating shaft is higher than a center of the first rotating shaft; one end of the second link 324 and the front connector 321 are rotatably connected by a third rotating shaft; the other end of the first link 323 and the second link 324 close to the third rotating shaft are rotatably connected by a fourth rotating shaft; one end of the third link 325 and the fourth rotating shaft are rotatably connected; one end of the fourth link 326 and the front connector 321 close to the front cross member 12 are rotatably connected by a fifth rotating shaft; the fourth link 326 is M-shaped, the other end of the third link 325 and a middle portion of the fourth link 326 are rotatably connected by a sixth rotating shaft; a support rod 33 is connected between two second links 324, and both ends of the support rod 33 are respectively connected with the corresponding second link 324 by a link connector 327; the support rod 33 is connected between two fourth links 326, and both ends of the support rod 33 are respectively connected with the corresponding fourth link 326 by the link connector 327; and the support rods 33 play a role of supporting the canopy cloth 35, and the first link assembly 31 and the second link assembly 32 act together to realize relative rotation between the front roof portion 1 and the rear roof portion 2 with the first rotating shaft as a fulcrum.

In one embodiment, as shown in FIG. 1, the folding roof further includes a support block 34, the support block 34 is connected to the rear connector 322, and after the front roof portion 1 is folded, the support block 34 fits the front connector 321 to support the front roof portion 1.

In one embodiment, as shown in FIG. 1, the folding roof further includes a gas spring 5 which achieves a buffering effect when the middle roof portion 3 is opened, and the structure of the gas spring 5 is the prior art and will not be described in detail; and a fixed end of the gas spring 5 is rotatably connected to the front connector 321, and a free end of the gas spring 5 is rotatably connected to the rear connector 322.

In one embodiment, as shown in FIG. 2, the folding roof further includes a pull wire mechanism 4 for preventing the canopy cloth 35 from wrinkling and deforming, and in the process of folding the canopy cloth 35, the pull wire mechanism 4 can be adjusted in a follow-up manner to prevent the canopy cloth 35 from wrinkling and deforming; and the pull wire mechanism 4 is located in the corresponding front soft roof frame 11 and rear soft roof frame 21, so that the canopy cloth 35 can fit the corresponding front soft roof frame 11 and rear soft roof frame 21 to form the middle roof portion 3.

In one embodiment, as shown in FIGS. 2 and 6, the pull wire mechanism 4 includes a tension spring 41 and a pull wire 44 connected to the rear soft roof frame 21 or the front soft roof frame 11, and the tension spring 41 is connected to the rear soft roof frame 21 by a tension spring fixing plate 43; and one end of the pull wire 44 fits the tension spring 41, and the other end of the pull wire 44 passes through a corresponding edge of the canopy cloth 35 and is connected with a pull wire bracket 45 on the front soft roof frame 11 or the rear soft roof frame 21, and since one end of the pull wire 44 is provided with the tension spring 41, a length of the pull wire 44 can be adjusted in a follow-up manner.

In one embodiment, an outer surface of the tension spring 41 is sheathed with a rubber sleeve 42 which can prevent friction noise; and a connecting hole is provided on the rubber sleeve 42, and a hook portion of the tension spring 41 fits the connecting hole to prevent the rubber sleeve 42 from being displaced.

In one embodiment, a spherical body 441 is formed on one end of the pull wire 44, and the tension spring 41 is a tower-shaped tension spring or a conical spring with a conical space, which is the prior art and will not be described in detail; and the spherical body 441 is located in the conical space of the tension spring 41, which facilitates the other end of the pull wire 44 to pass through the conical space, and further facilitates mounting of the pull wire 44.

In one embodiment, as shown in FIGS. 10 and 11, the second lock catch 24 includes a lock catch body 241; the lock catch body 241 has a snap-fit portion 242 and an operating portion 243, and the snap-fit portion 242 and the operating portion 243 are L-shaped to facilitate operation, that is, the operating portion 243 only needs to be rotated 90 degrees to reach a locking state or a separate state; the lock catch body 241 is provided with a lock catch mounting hole 244, and the lock catch mounting hole 244 is rotatably connected to the rear cross member 22 by a bolt connector 245; and the operating portion 243 is operated to drive the snap-fit portion 242 to rotate, so that the snap-fit portion 242 is snapped to or separated from the vehicle body, and the rear roof portion 2 is snap-fitted to or separated from the vehicle body.

In one embodiment, the folding roof further includes a bushing 246, the bushing 246 is connected in the lock catch mounting hole 244, and the bolt connector 245 movably passes through the bushing 246 and is rotatably connected with the rear cross member 22, and the bushing 246 enables the operation of the second lock catch 24 to be smooth.

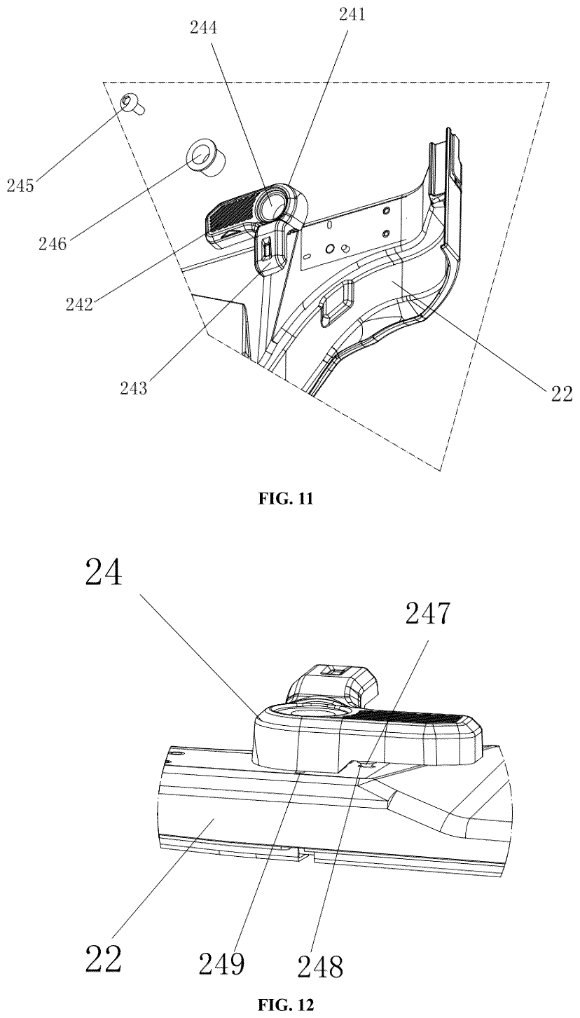

In one embodiment, in order to prevent misoperation, as shown in FIG. 12, the folding roof further includes an foolproof mechanism, the foolproof mechanism includes a spring touch bead 247 provided on the operating portion 243, and a touch bead portion of the spring touch bead 247 normally protrudes to a bottom surface of the operating portion 243; the rear cross member 22 is provided with a first foolproof hole 248 and a second foolproof hole 249 which fit the touch bead portion of the spring touch bead 247, a distance between a center of the first foolproof hole 248 and a center of the lock catch mounting hole 244 is the same as a distance between a center of the second foolproof hole 249 and the center of the lock catch mounting hole 244; when the touch bead portion of the spring touch bead 247 fits the first foolproof hole 248, the snap-fit portion 242 is snap-fitted to the vehicle body; on the contrary, when the touch bead portion of the snap-fit portion 242 fits the second foolproof hole 249, the snap-fit portion is separated from the vehicle body; and the operating portion 243 needs to overcome a spring force of the spring touch bead 247 to rotate, and the touch bead portion of the spring touch bead 247 fits the foolproof hole 248 to realize proper snap-fit to prevent misoperation.

In one embodiment, a front end of the canopy cloth 35 is connected with the front roof portion 1 by a front fixing mechanism; as shown in FIG. 13, the front fixing mechanism includes a front groove piece 61 embedded on a front bottom surface of the front cross member 12 of the front roof portion 1, and the material of the front groove piece 61 is plastic, but not limited to plastic; and the front end of the canopy cloth 35 is snapped in the front groove piece 61 by a first front snap-in strip 62. Specifically, the first front snap-in strip 62 is inserted into a penetrating portion on the front end of the canopy cloth 35, and the penetrating portion is cylindrical; and then the first front snap-fit strip 62 is snapped in the front groove piece 61 to fix the front end of the canopy cloth 35 on the front roof portion 1.

In one embodiment, the front fixing mechanism further includes a second front snap-in piece 63, the second front snap-in piece 63 is connected to the canopy cloth 35, and the second front snap-in piece 63 is snap-fitted to a rear portion of the front cross member 12 of the front roof portion 1 to further enhance fixing of the canopy cloth 35 to the front roof portion 1, achieving the effect of fixing the canopy cloth 35; and a front snap-in groove 64 adapted to the second front snap-in member 63 is provided on a rear portion of the front cross member 12 of the front roof portion 1 to facilitate connection of the second front snap-in piece 63.

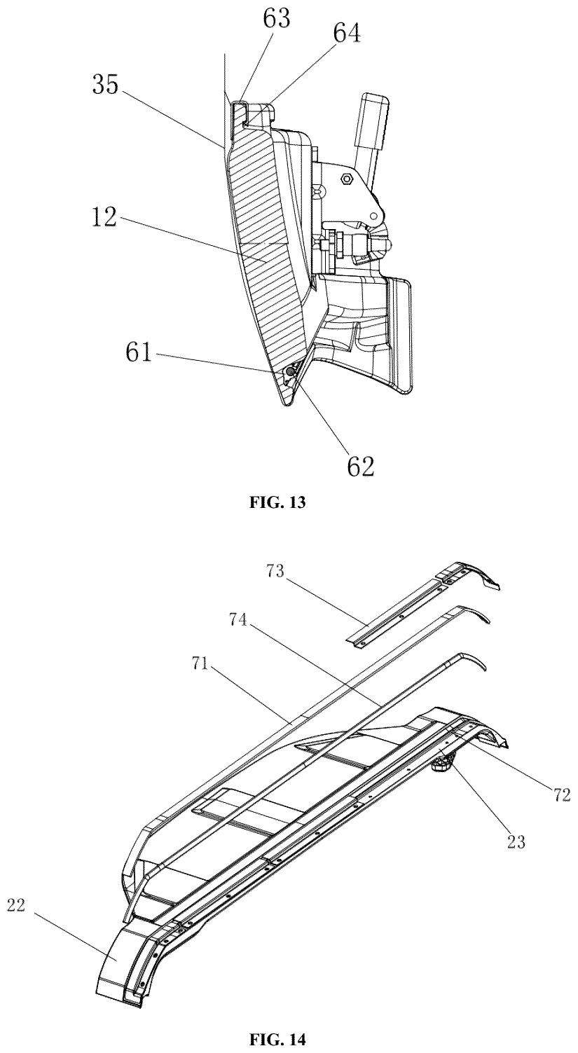

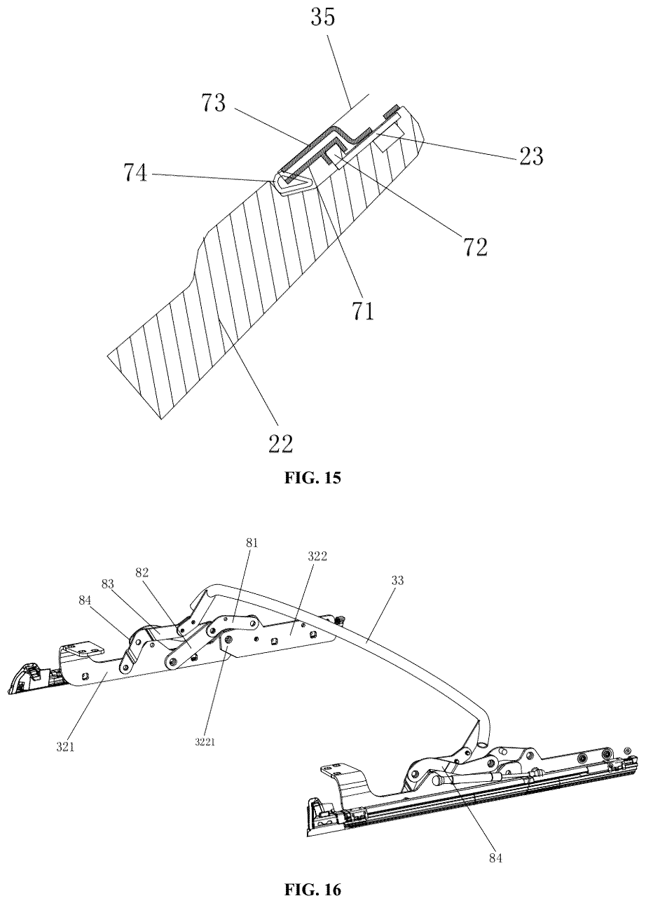

In one embodiment, a rear end of the canopy cloth 35 is connected with the rear roof portion 2 by a rear fixing mechanism; and as shown in FIGS. 14 and 15, the rear fixing mechanism includes a rear snap-fit strip 71 connected with the rear end of the canopy cloth 35, and the rear snap-fit strip 71 is snap-fitted to a raised portion 72 of the rear cross member 22 of the rear roof portion 2 to facilitate fixing of the rear end of the canopy cloth 35.

In one embodiment, the rear fixing mechanism further includes a pressing plate 73, the pressing plate 73 is detachably connected with the corresponding nutted connector 23, and the pressing plate 73 further presses the rear snap-fit strip 71 to further enhance the fixing effect of the canopy cloth 35.

In one embodiment, the rear fixing mechanism further includes a rear sealing strip 74, and rear sealing strip 74 is located at a position where the rear snap-in strip 71 fits the rear cross member 22 to prevents water from entering the vehicle therefrom; and the rear cross member 22 is provided with a drainage groove to facilitate water drainage and further have a waterproofing effect.

In the implementation, the front roof portion 1 is connected with the vehicle body by the first lock catch 15, and the rear roof portion 2 is connected with the vehicle body by the second lock catch 24, thus realizing mounting of the folding roof and the vehicle body; when the folding roof needs to be folded, the first lock catch 15 is opened, and under the action of an external force, folding is carried out through the link assembly of the middle roof portion 3 to achieve the folding of the roof, the middle roof portion 3 adopts a soft roof design, so that the folded roof occupies a small space; and the second lock catch 24 can also be opened to remove the whole folding roof, thus realizing convenient disassembly of the folding roof and having strong practicability.

As described above, in the present application, the design of the front fixing mechanism, the rear fixing mechanism and the pull wire mechanism enables the soft roof and the hard roof to be quickly convertible, the hard roof is used as a connection portion with the vehicle body, and the lock catch is used for fit to facilitate disassembly, and the hard roof is combined with the soft roof, so that the overall space of the folded roof is small; and the support rods are fixed on the first link assembly and the second link assembly, which enables to change positions in the process of opening or closing the roof in a follow-up manner, thus achieving the effect of supporting the canopy cloth when the roof is closed and folding the canopy cloth and occupying a small space when the roof is opened. The gas spring is mounted on the middle roof portion to achieve a buffering effect when the roof is opened. The front soft roof frame and the rear soft roof frame are respectively provided with side sealing strips through fixing brackets, so that the fixing bracket can be adjusted to achieve the optimal sealing effect. The pull wire passes through the edge of the canopy cloth to prevent the canopy cloth from wrinkling and deforming. One end of the pull wire is provided with a tension spring structure, which enables to adjust the length of the pull wire in a follow-up manner.

### Embodiment 2

Based on the different design of the canopy, the length of the middle roof portion 3 also changes accordingly, and the difference between Embodiment 2 and Embodiment 1 is that: the structure of the four-link mechanism is different, and other structures are the same. Specifically, as shown in FIG. 16, the four-link mechanism includes a fifth link 81, a sixth link 82, a seventh link 83 and an eighth link 84, and one end of the fifth link 81 and the rear connector 322 close to the rear rotary connection portion 3221 are rotatably connected by a seventh rotating shaft; one end of the sixth link 82 and the front connector 321 are rotatably connected by an eighth rotating shaft; the other end of the fifth link 81 and the other end of the sixth link 82 are rotatably connected by a ninth rotating shaft; one end of the seventh link 83 and the front connector 321 are rotatably connected by an eleventh rotating shaft, one end of the eighth link 84 is rotatably connected with the eighth rotating shaft, and the other end of the eighth link 84 is rotatably connected with a middle and lower portion of the seventh link 83 by a tenth rotating shaft; and a support rod 33 is connected between upper portions of two seventh links 83 to support the canopy cloth.

A vehicle according to another embodiment of the present application includes a folding roof as described above.

It should be noted that the terminology used herein are only for the purpose of describing specific embodiments, and is not intended to limit the exemplary embodiments according to the present application. As used herein, unless the context clearly dictates otherwise, the singular form is also intended to include the plural form. In addition, it should also be understood that when the terms “comprising” and/or “including” are used in this specification, they are indicative of the presence of features, steps, operations, devices, assemblies and/or combinations thereof.

Unless specifically stated otherwise, the relative arrangement of components and steps, numerical expressions, and numerical values set forth in these embodiments do not limit the scope of the present invention. Also, it should be understood that the dimensions of the various parts illustrated in the drawings are not drawn to scale for ease of description. Techniques, methods, and apparatus known to those of ordinary skill in the relevant art may not be discussed in detail, but the techniques, methods, and apparatus should be considered part of the description where appropriate. In all examples shown and discussed herein, any particular value should be interpreted as exemplary only and not as limiting. Thus, other examples of exemplary embodiments may have different values. It should be noted that similar reference numerals and letters indicate similar items in the following drawings, and therefore, once an item is defined in one figure, it is not required to be further discussed in the subsequent figures.

In the description of the present application, it should be understood that the orientation or positional relationship indicated by the locative words such as “front, rear, upper, lower, left, right”, “horizontal, vertical, perpendicular, horizontal” and “top, bottom” is merely for convenience of describing the present application and simplifying the description. In the absence of explanation to the contrary, these locative words do not indicate and imply that the device or element to be referred must have a specific orientation or to be constructed and be operated in a specific orientation, and thus, should not be construed as limiting the protection scope of the present application. The locative words “inside and outside” refer to inside and outside the profile relative to each component itself.

For ease of description, spatially relative terms, such as “on”, “above”, “on the upper surface”, “upper” and the like, may be used herein to describe the spatial positional relationship of one device or feature to other devices or features as shown in the drawings. It will be understood that the spatially relative terms are intended to encompass different orientations in use or operation in addition to the orientation depicted in the drawings. For example, if a device in the drawings is inverted, devices described as “above” or “over” other devices or structures are positioned “below” or “beneath” the other devices or structures. Thus, the exemplary term “above” may encompass both the “above” and “below” orientations. The device may also be located in other different ways (rotating by 90 degrees or at other orientations), and the spatially relative descriptions used herein are explained accordingly.

In addition, it is to be noted that the use of the words “first”, “second” and the like to define components is merely for the convenience of distinguishing the corresponding components. If not otherwise stated, the above words do not have a special meaning, and thus should not be construed to limit the protection scope of the present application.

In the description of the present invention, it should be noted that, unless expressly and specifically defined otherwise, the terms “mounted”, “provided”, “connected” and the like are to be interpreted broadly, and may, for example, be fixedly or detachably or integrally connected; may be mechanically connected or electrically connected; or may be directly connected or indirectly connected through an intermediary, and may be the internal communication between two elements. The specific meaning of the above terms in the present invention can be understood by those of ordinary skill in the art from the specific context.

The above descriptions are only preferred embodiments of the present invention, and all equivalent changes and modifications made according to the scope of the present invention shall fall within the scope of the present invention.

What is claimed is:

1. A folding roof, comprising: a front roof portion, a rear roof portion and a middle roof portion, wherein the middle roof portion is connected between the front roof portion and the rear roof portion, and the front roof portion and the rear roof portion are foldable relative to each other through the middle roof portion;
the front roof portion is a hard shell portion, the rear roof portion is a hard shell portion, the middle roof portion comprises a canopy cloth, the canopy cloth is made of a soft material, and the canopy cloth is a soft roof portion;
the middle roof portion further comprises a front soft roof frame respectively provided on both sides of the front roof portion and a rear soft roof frame respectively provided on both sides of the rear roof portion, one end of the front soft roof frame is connected with the front roof portion, and one end of the rear soft roof frame is connected with the rear roof portion; a front portion of the canopy cloth is connected with the front roof portion, and a rear portion of the canopy cloth is connected with the rear roof portion; both side edges of the canopy cloth are matched with the corresponding front soft roof frame and rear soft roof frame; and
a front end of the canopy cloth is connected with the front roof portion by a front fixing mechanism; and a rear end of the canopy cloth is connected with the rear roof portion by a rear fixing mechanism.

2. The folding roof according to claim 1, wherein the front roof portion comprises a front cross member, a first connector is embedded in the front cross member, and a first lock catch is connected to the first connector; and
the rear roof portion comprises a rear cross member, and a second lock catch is connected to the rear cross member.

3. The folding roof according to claim 1, further comprising a pull wire mechanism, wherein the pull wire mechanism comprises a tension spring and a pull wire connected to the rear soft roof frame, the tension spring is connected to the rear soft roof frame, one end of the pull wire is matched with the tension spring, and the other end of the pull wire passes through a corresponding edge of the canopy cloth and is connected with a pull wire bracket on the front soft roof frame.

4. The folding roof according to claim 1, wherein the middle roof portion further comprises a first link assembly and a second link assembly arranged at intervals, more than one support rod is connected between the first link assembly and the second link assembly, fixing cloth strips are connected to the canopy cloth, the fixing cloth strips are connected with the support rods, and the first link assembly is structurally symmetrical to the second link assembly.

5. The folding roof according to claim 4, wherein the second link assembly comprises a front connector and a rear connector, the front connector is connected with the corresponding front soft roof frame, the rear connector is connected with the corresponding rear soft roof frame, one end of the front connector is connected with the front cross member by a second connector, one end of the rear connector is connected with the rear cross member, a front rotary connection portion is formed on the other end of the front connector, one end of the rear connector is connected with the rear cross member, a rear rotary connection portion is formed on the other end of the rear connector, and the front rotary connection portion and the rear rotary connection portion are rotatably connected by a first rotating shaft, so that the front roof portion and the rear roof portion rotate relative to each other with the first rotating shaft as a fulcrum.

6. The folding roof according to claim 5, further comprising a gas spring, wherein a fixed end of the gas spring is rotatably connected to the front connector, and a free end of the gas spring is rotatably connected to the rear connector.

7. The folding roof according to claim 5, wherein the second link assembly further comprises a four-link mechanism.

8. The folding roof according to claim 7, wherein the four-link mechanism comprises a first link, a second link, a third link and a fourth link, one end of the first link and the rear connector are rotatably connected by a second rotating shaft, and a center of the second rotating shaft is higher than a center of the first rotating shaft; one end of the second link and the front connector are rotatably connected by a third rotating shaft; the other end of the first link and the second link close to the third rotating shaft are rotatably connected by a fourth rotating shaft; one end of the third link and the fourth rotating shaft are rotatably connected; one end of the fourth link and the front connector are rotatably connected by a fifth rotating shaft; the other end of the third link and a middle portion of the fourth link are rotatably connected by a sixth rotating shaft; a support rod is connected between two second links, and both ends of the support rod are respectively connected with the corresponding second link by a link connector; a support rod is connected between two fourth links, and both ends of the support rod are respectively connected with the corresponding fourth link by a link connector.

9. The folding roof according to claim 7, wherein the four-link mechanism comprises a fifth link, a sixth link, a seventh link and an eighth link, and one end of the fifth link and the rear connector are rotatably connected by a seventh rotating shaft; one end of the sixth link and the front connector are rotatably connected by an eighth rotating shaft; the other end of the fifth link and the other end of the sixth link are rotatably connected by a ninth rotating shaft; one end of the seventh link and the front connector are rotatably connected by an eleventh rotating shaft, one end of the eighth link is rotatably connected with the eighth rotating shaft, and the other end of the eighth link is rotatably connected with a middle and lower portion of the seventh link by a tenth rotating shaft; and a support rod is connected between upper portions of two seventh links.

10. A vehicle, comprising a vehicle body, wherein a folding roof according to claim 1 is connected to the vehicle body.
